(19) United States
(12) Patent Application Publication
(10) Pub. No.: US 2010/0096822 A1
(43) Pub. Date: Apr. 22, 2010

(54) MOTORCYCLE FOOT STEERING

(76) Inventor: Glenn David Swenson, Portland, OR (US)

Correspondence Address: Goff Patent Law PLLC, P.O. Box 625, Brush Prairie, WA, 98606, US

(21) Appl. No.: 12/580,810

(22) Filed: Oct. 16, 2009

Related U.S. Application Data
(60) Provisional application No. 61/106,312, filed on Oct. 17, 2008.

(51) Int. Cl. B62D 1/22

(52) U.S. Cl. 280/87.1

(57) ABSTRACT

A foot pedal can be positioned to receive a force from a motorcycle operator's foot, and a force transfer system can be configured to transfer forces on the pedal to pivot the motorcycle wheel in multiple directions and assist in steering a motorcycle. Forces from a motorcycle operator's foot can be applied to a device a motorcycle. The forces can be transferred from the device to a motorcycle wheel, and the transferred force can pivot the motorcycle wheel about an axis other than an axis of rotation of the motorcycle wheel in two opposing directions.

### CROSS-REFERENCE TO RELATED APPLICATIONS

This application is a nonprovisional application claiming priority to U.S. Provisional Application No. 61/106,312, filed Oct. 17, 2008 and titled Motorcycle Foot Steering, which is incorporated herein by reference.

### TECHNICAL FIELD

The description relates generally to vehicle steering, and more particularly to foot steering of a motorcycle.

### BACKGROUND

Motorcycles have traditionally been steered by applying pressure to the handlebars. More specifically, when a motorcycle operator desires to turn to the left, the operator applies a pressure to the handlebars to turn the front of the front wheel slightly to the right. This counter-intuitive steering, known as counter-steering, causes the motorcycle to lean to the left. As the motorcycle leans to the left, the front of the front wheel is brought back to the left and the operator leans to the left with the motorcycle in the turn. To straighten the motorcycle out of the turn, the operator again uses counter-steering, applying pressure to the handlebars to turn the front of the wheel slightly to the left. This causes the motorcycle to lean back to the right, bringing the motorcycle out of the left lean and straightening the front wheel. An operator takes opposite actions to steer a motorcycle to the right.

### SUMMARY

Whatever the advantages of previous motorcycle steering controls, they have neither recognized the foot steering tools or techniques described and claimed herein, nor the advantages produced by such foot steering tools and techniques.

The present inventor has recognized the advantages of using an operator's feet to pivot the front wheel of the motorcycle to the left or right when steering a motorcycle. Such advantages include the ability to rest the operator's hands and arms during long motorcycle rides, thereby decreasing the energy exerted by the operator during such rides. The present inventor has also recognized that such steering a motorcycle using the operator's feet can be done safely. Moreover, an operator can use the operator's feet and hands for steering to provide even more control over the motorcycle in some situations, thereby increasing safety for the operator.

According to one embodiment, a foot pedal can be positioned to receive forces from a motorcycle operator's foot. A force transfer system between the pedal and a motorcycle wheel can be configured to transfer forces on the pedal to pivot the motorcycle wheel in multiple pivotal directions and assist in steering a motorcycle.

According to another embodiment, a motorcycle can include a rear wheel, a front wheel, and a motor. The motorcycle can also include a pedal located to receive forces from an operator's foot, and means for pivoting the front wheel in multiple directions about a steering axis and assisting in steering the motorcycle by transferring forces from the pedal to the front wheel.

According to yet another embodiment, a first force from a motorcycle operator's foot can be applied to a toe region of a device attached to a motorcycle. The first force can be transferred from the device to a motorcycle wheel, and the transferred first force can pivot the motorcycle wheel about a steering axis other than an axis of rotation of the motorcycle wheel. Additionally, a second force can be applied from the foot to a heel region of the device. The second force can be transferred from the device to the motorcycle wheel. The transferred second force can pivot the motorcycle wheel in the second direction about the steering axis, and the second direction can be opposite from the first direction.

This Summary is provided to introduce a selection of concepts in a simplified form. The concepts are further described below in the Detailed Description. This Summary is not intended to identify key features or essential features of the claimed subject matter, nor is it intended to be used to limit the scope of the claimed subject matter. Similarly, the invention is not limited to implementations that address the particular techniques, tools, environments, disadvantages, or advantages discussed in the Background, the Detailed Description, or the attached drawings.

### BRIEF DESCRIPTION OF THE DRAWINGS

FIG. 1 is a right side view of a motorcycle that includes foot steering features.

FIG. 2 is an enlarged broken-away right side view of the motorcycle of FIG. 1.

FIG. 3 is an enlarged broken-away left side view of the motorcycle of FIG. 1.

FIG. 4 is an isometric view illustrating an interface between a foot steering cable system and a front motorcycle fork.

FIG. 5 is a right side view illustrating an interface between a foot steering cable system and a right side foot steering pedal.

FIG. 6 is a right side view illustrating an alternative interface between a foot steering cable system and a right side foot steering pedal.

FIG. 7 is an isometric view of the foot steering pedal and cable system interface of FIG. 6.

FIG. 8 is a right side view illustrating another alternative embodiment of an interface between a foot steering cable system and a right side foot steering pedal.

FIG. 9 is a left side view illustrating another alternative embodiment of an interface between a foot steering cable system and a left side foot steering pedal similar to the right side foot steering pedal of FIG. 8.

FIG. 10 is a schematic diagram illustrating a foot steering system including independent parallel control cable routing.

FIG. 11 is a schematic diagram illustrating a foot steering system including dependent series control cable routing.

FIG. 12 is a flow diagram illustrating some operations that can be performed during foot steering of a motorcycle.

The description and drawings may refer to the same or similar features in different drawings with the same reference numbers.

### DETAILED DESCRIPTION

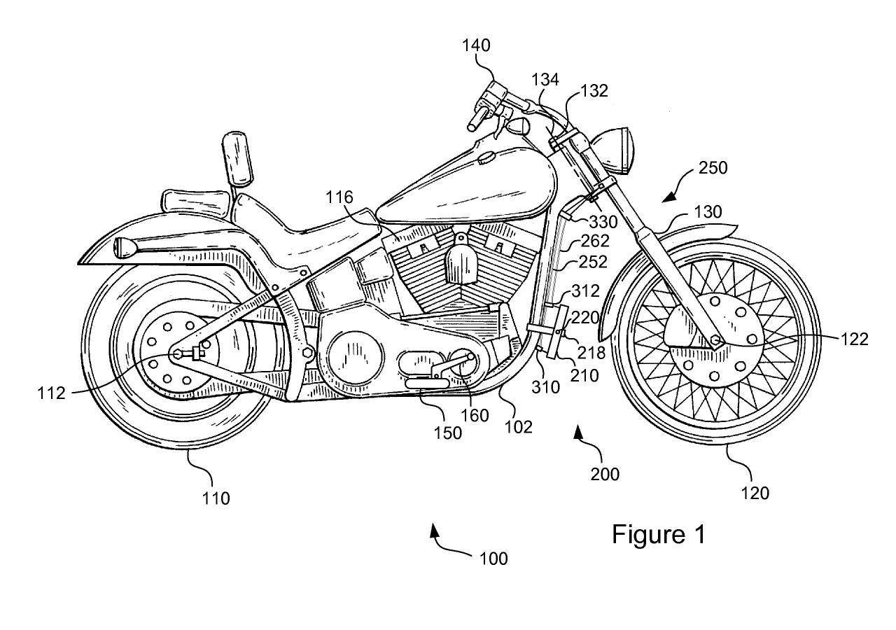

Referring to FIG. 1, a motorcycle (100) includes a frame (102). As used herein, the term motorcycle refers to a wheeled motorized vehicle that an operator balances while riding and that leans from side to side during steering. A rear wheel (110) can be mounted to a rear of the frame (102), and spin about a rotation axis (112) as it is driven by an engine (116). A front wheel (120) spins about a rotation axis (122), and can be mounted to a front of the frame (102) by a front fork (130) that extends from a front steering pivot (132) and down on opposite sides of the front wheel (120). Thus, handlebars (140) secured to the front fork (130) can be used to pivot the front wheel (120) about a front steering axis (134) that extends through the front steering pivot (132). The front steering axis (134) is different from the rotation axis (122) of the front wheel (120). The motorcycle (100) can also include a standard foot rest (150) and brake lever (160). The motorcycle parts mentioned above in this paragraph can all be standard motorcycle parts.

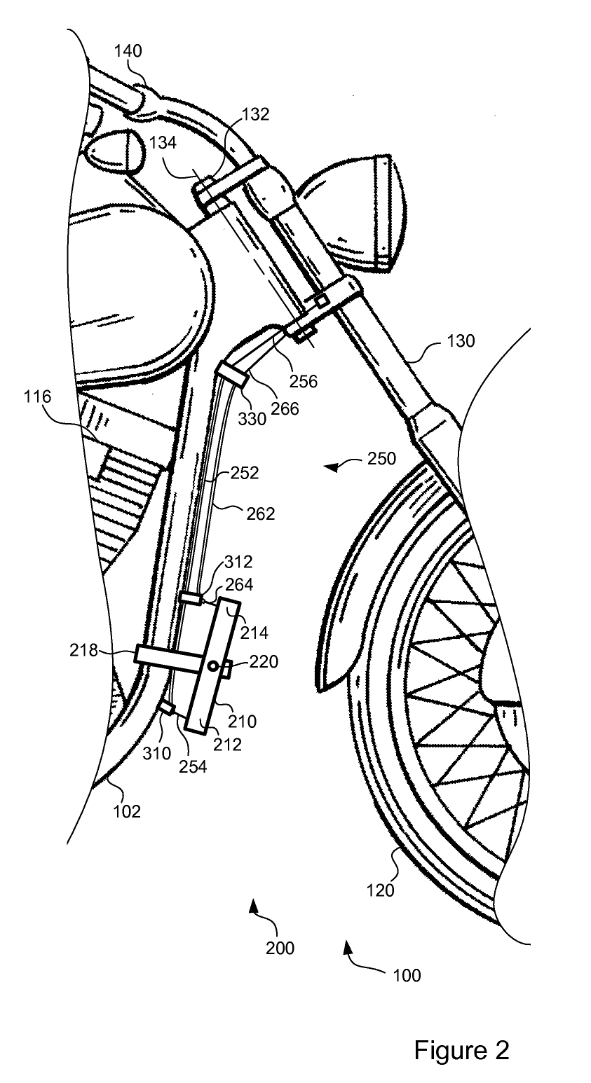

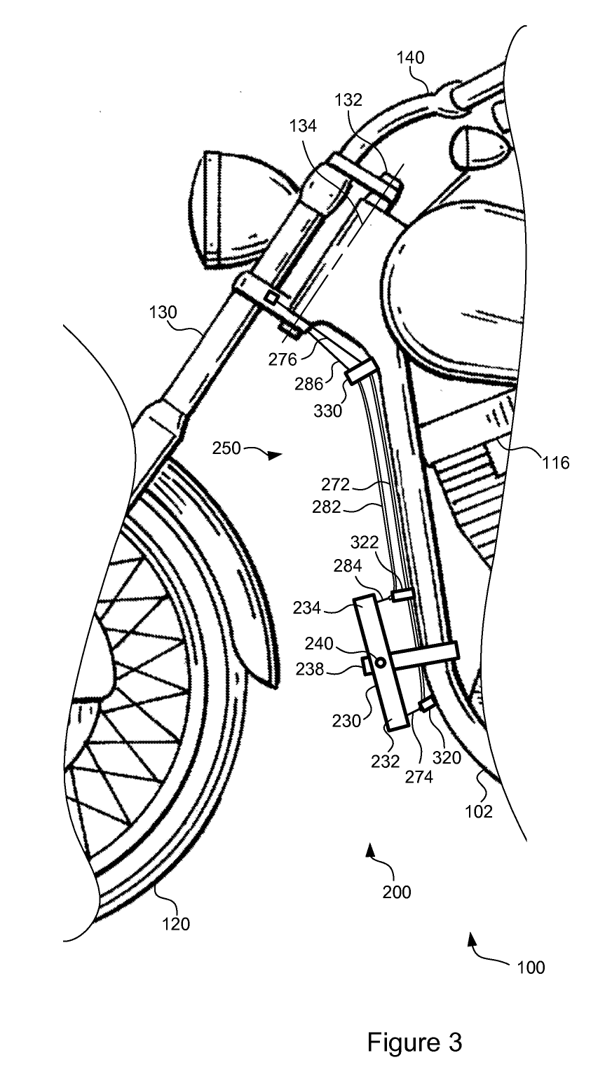

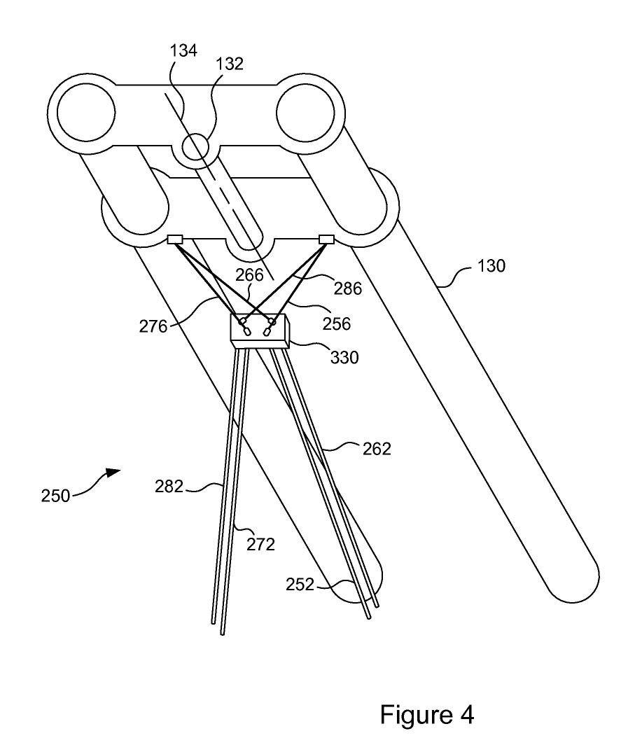

Referring to FIGS. 1-5, the motorcycle (100) includes a foot steering system (200). The foot steering system (200) can use force from an operator's foot to pivot the front wheel (120) of the motorcycle (100) about a steering axis (134) formed by the steering pivot (132). This allows a motorcycle operator to steer the motorcycle (100) using one or more of his or her feet instead of, or in addition to, his or her hand(s).

This arrangement produces substantial benefits that are not present in or predictable from prior motorcycle steering systems. For example, it has generally been believed that a motorcycle operator needs to keep his or her hand(s) on the motorcycle handlebars while riding to maintain proper control, especially when the operator is turning the motorcycle. The present inventor has discovered, contrary to this conventional belief, that at least for slight turns at high speeds, such as on a highway, a foot steering system such as the one described and illustrated herein, can safely be used to pivot the front wheel (120) about the steering axis (134). This foot steering system (200) can be used instead of the traditional handlebar steering system in some situations, such as where slight turns are desired. Moreover, in some situations it can be beneficial to use the foot steering system (200) together with the traditional handlebar steering system to maintain better control of the pivotal movement of the front wheel (120). Whether the foot steering system (200) is used instead of or in addition to the traditional handlebar system, it can help relieve or avoid fatigue of the operator's hands and arms while operating the motorcycle (100). Additionally, the foot steering system (200) can provide a motorcycle operator with a greater sense of freedom and control while operating the motorcycle (100), and thereby enhance the motorcycle experience.

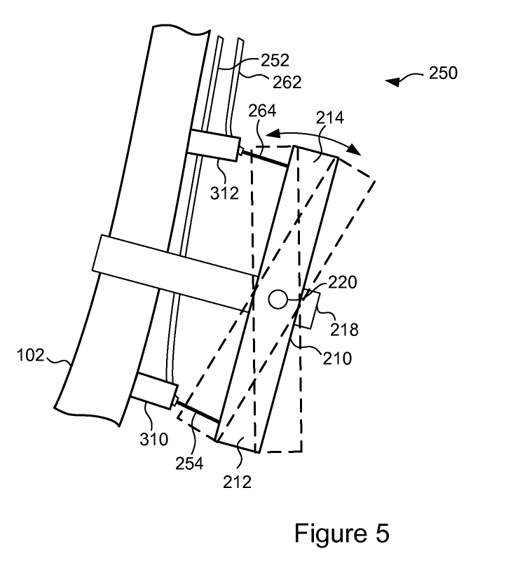

Referring still to FIGS. 1-5, the foot steering system (200) can include a force receiving device including a moveable right pedal (210) having a lower heel end (212) and an upper toe end (214). The right pedal (210) can be positioned so that an operator on the motorcycle can rest his or her right foot on the right pedal (210) and apply a force to the heel end (212) and/or the toe end (214) of the pedal (210). The right pedal (210) can be mounted directly or indirectly to the motorcycle frame. For example, the right pedal (210) can be mounted to the front of the motorcycle frame (102) with a right pedal-mounting bracket (218), which clamps to the right side of the front of the frame (102). The right pedal (210) is allowed to pivot back and forth about a right pedal pivot (220), which can include a pin extending through the pedal. This pivotal movement is illustrated by the dashed pedal illustrations and the movement-indicating arrow in FIG. 5. Similarly, the foot steering system can include a force receiving device including a moveable left pedal (230) having a lower heel end (232) and/or an upper toe end (234). The left pedal (230) can be mounted using a left pedal-mounting bracket (238) in a manner similar to the mounting of the right pedal (210). Thus, the left pedal (230) can be mounted so that it can pivot about a left pedal pivot (240).

The left and right pedals can be mounted so that they move in some way other than as illustrated and described above. For example, the pedals could be mounted with pivots closer to the heel or toe end, or they could be mounted to allow sliding movement rather than pivotal movement. Moreover, the foot steering system (200) can include a single pedal rather than multiple pedals.

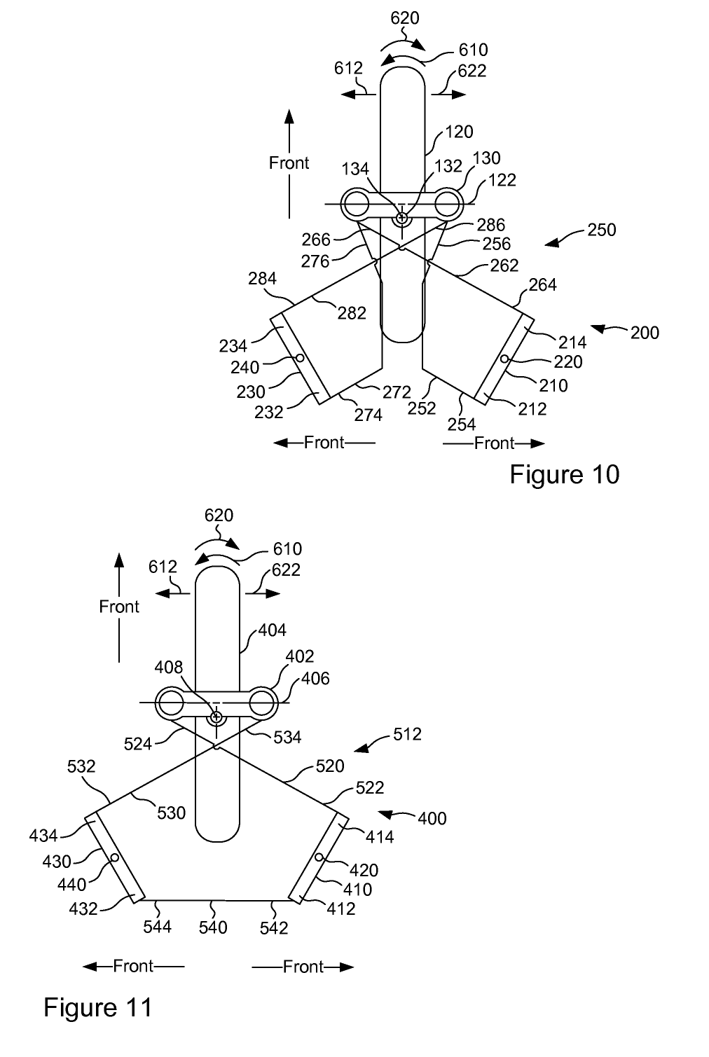

The foot steering system (200) can also include a force transfer system, such as a cable system (250), which transfers force from the pedals (210, 230) to the front fork (130) of the motorcycle. The force transfer system can also include the front fork (130) itself. The pedals (210, 230) can be located near the motorcycle frame, remotely from the front fork (130) as shown, with the force transfer system including a cable system or other system for transferring the force from the pedals to the front fork, as described below. As illustrated in FIGS. 1-5 and in schematic form in FIG. 10, the cable system (250) can include a right heel cable (252) having a pedal end (254) connected to the heel end (212) of the right pedal (210). The opposite end of the right heel cable (252) can be a fork end (256) that can be connected to the right side of the front fork (130). A right toe cable (262) can have a pedal end (264) that can be connected to the toe end (214) of the right pedal (210), and an opposite fork end (266) that can be connected to the left side of the front fork (130). The cable system (250) can also include a left heel cable (272) that has a pedal end (274) connected to the heel end (232) of the left pedal (230) and an opposite fork end (276) that can be connected to the left side of the front fork (130). The cable system can also include a left toe cable (282) that can have a pedal end (284) connected to the toe end (234) of the left pedal (230) and an opposite fork end (286) that can be connected to the right side of the front fork (130). Thus, the cable system (250) can include a right pedal subsystem that includes the right cables (252 and 262) to transfer forces from the right pedal (210), and a left pedal subsystem that includes the left cables (272 and 282) to transfer forces from the right pedal (230). Accordingly, each sub-system can transfer forces to steer the motorcycle with a single pedal even without the other subsystem.

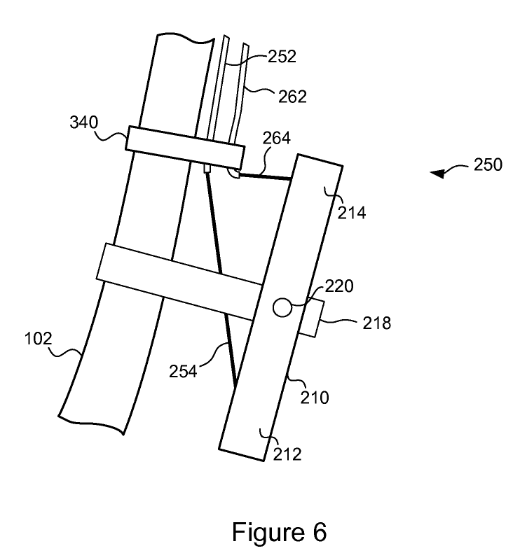

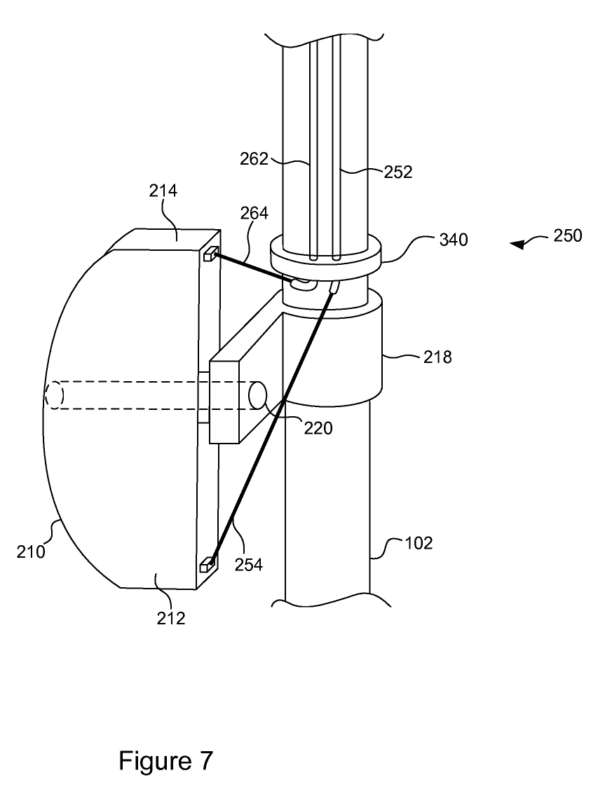

The cables (252, 262, 272, and 282) can be conventional cables, such as motorcycle brake cables, bicycle brake cables, or aircraft grade cables. Moreover, the cables can be mounted in a conventional manner using brackets secured the motorcycle frame (102) and to the cable housings. For example, a lower right heel cable-mounting bracket (310) can secure the pedal end (254) of the right heel cable (252) housing to the frame (102), and a lower right toe cable mounting bracket (312) can secure the pedal end (264) of the right toe cable (262) housing to the frame (102). Similarly, a lower left heel cable-mounting bracket (320) can secure the pedal end (274) of the left heel cable (272) housing to the frame (102) and a lower left toe cable-mounting bracket (322) can secure the pedal end (284) of the left toe cable (282) housing to the frame (102). An upper cable-mounting bracket (330) can secure the fork ends (256, 266, 276, and 286) of the housings of the cables (252, 262, 272, and 282) to the frame (102) near the top of the front fork (130). The cables could be secured in many other different ways. For example, as is illustrated in FIGS. 6-7, the housings at the pedal ends (254 and 264) of the right heel and toe cables (252 and 262) could both be secured with a single combined right lower cable housing mounting bracket (340). The left side cables could be secured in the same manner. In addition, the fork ends (256, 266, 276, and 286) of the housings of the cables (252, 262, 272, and 282) could be secured to the frame (102) with multiple brackets, rather than a single bracket.

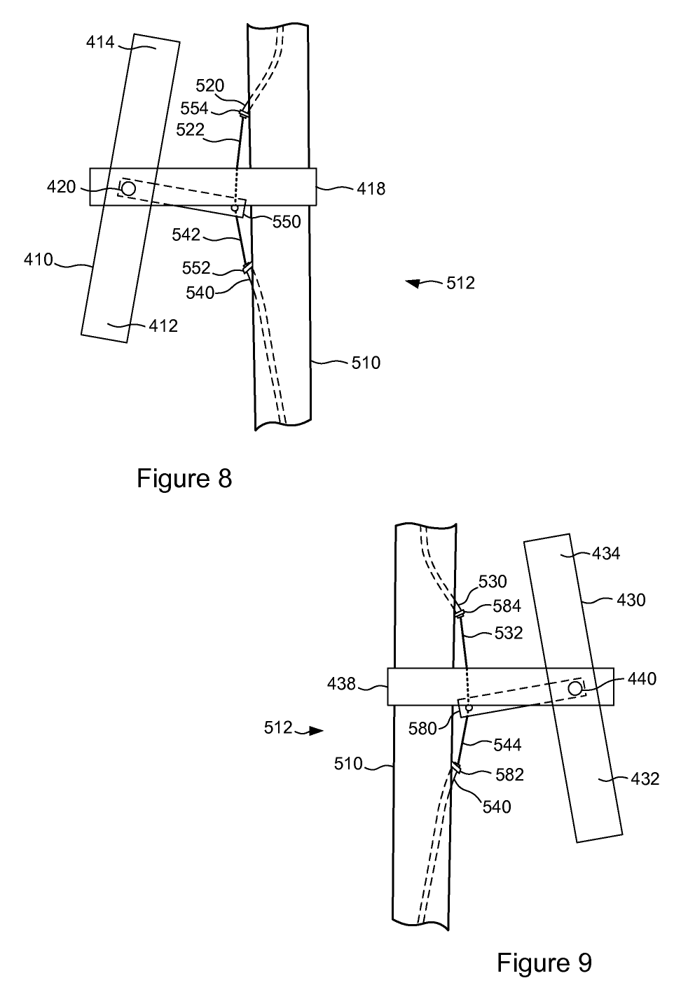

As yet another alternative illustrated in FIGS. 8-9 and 11, a foot steering system (400) for a motorcycle can have a front motorcycle fork (402) pivotally attached to a front wheel (404) so that the front wheel spins about a rotation axis (406) and pivots for steering about a front steering axis (408) (see FIG. 11). The foot steering system (400) can include a right pedal (410) with a heel end (412) and a toe end (414). The right pedal-mounting bracket (418) can be secured to the right pedal (410) so that the right pedal (410) can pivot about a right pedal pivot (420). Similarly, a left pedal (430) can include a heel end (432) and a toe end (434). The left pedal (430) can be mounted on a left pedal-mounting bracket (438) that allows the left pedal (430) to pivot about a left pedal pivot (440). The right and left mounting brackets (418, 438) can be mounted to respective right and left sides of a crash bar (510), which is in turn mounted to a motorcycle frame, with the mounting brackets (418, 438) extending back from the crash bar (510) so that the pedals (410, 430) are positioned behind the crash bar (510).

A cable system (512) of the foot steering system (400) can include a right pedal steering cable (520) with a pedal end (522) and an opposite fork end (524), a left pedal steering cable (530) with a pedal end (532) and an opposite fork end (534), and a tie cable (540) with a right pedal end (542) and an opposite left pedal end (544). The fork ends (524 and 534) can be mounted with an upper cable housing mounting bracket (not shown), similar to the upper cable housing mounting bracket (330) illustrated in FIGS. 1-4 and described above. As is illustrated in schematic form in FIG. 11, the fork end (524) of the right pedal steering cable (520) can be secured to the left side of the front motorcycle fork (402). Likewise, the fork end (534) of the left pedal steering cable (530) can be secured to the right side of the front motorcycle fork (402).

Referring back to FIGS. 8-9 and 11, the right pedal end (542) of the tie cable (540) and the pedal end (522) of the right pedal steering cable (520) can both be secured to a right cable lever (550), which is mounted on, and pivots with, the right pedal (410). A lower right tie cable-mounting bracket (552) can be secured to the cable housing at the right pedal end (542) of the tie cable (540) as the tie cable extends into the crash bar (510). The tie cable can extend through the crash bar (510) to a location near the left pedal (430). A lower right steering cable-mounting bracket (554) can be secured to the cable housing at the pedal end (522) of the right pedal steering cable (520). The right pedal steering cable (520) can extend through the crash bar and/or the motorcycle frame to a location near an upper cable housing mounting bracket (not shown).

Similarly, the left pedal end (544) of the tie cable (540) and the pedal end (532) of the left pedal steering cable (530) can both be secured to a left cable lever (580), which is mounted on, and pivots with, the left pedal (430). A lower left tie cable-mounting bracket (582) can secure the housing at the left pedal end (544) of the tie cable (540) to the crash bar (510) as the tie cable (540) extends into the crash bar (510). A lower left steering cable-mounting bracket (584) can secure the housing at the pedal end (532) of the left pedal steering cable (530) to the crash bar (510). The left pedal steering cable (530) can extend through the crash bar and/or the motorcycle frame to a location near an upper cable housing mounting bracket (not shown). Thus, the cables can be generally hidden from view for this and other cable configurations by feeding them through the crash bar and/or the motorcycle frame.

The different overall cable systems (250 and 512) each provides somewhat different advantages. For example, the dependent series control cable routing cable system (512) of FIG. 11 is somewhat simpler than the independent parallel control cable routing system (250) of FIG. 10. However, the independent parallel control cable routing system (250) of FIG. 10 provides an added level of redundancy and safety because one of the pedals would continue to be operable for steering the motorcycle even if one of the pedals or cables were to break.

There are alternatives for the force transfer system other than cable systems. The force transfer system could transfer force using one or more gears interacting with one or more flexible or rigid shafts. As another example, the force transfer system could be a hydraulic system, wherein movement of left and right foot pedals could actuate one or more hydraulic rams that could actuate steering of the motorcycle front wheel. A pneumatic system could operate in a similar manner. Likewise, the force transfer system could be an electrical system, such as a system where movement of foot pedals activates actuators, such as solenoids, that could actuate steering of the motorcycle front wheel. Such a force transfer system could include wired and/or wireless connections to carry signals between one or more sensors and one or more actuators. Moreover, the force transfer system could be some combination of these types of systems, or some other type of system that can transfer forces from an operator's foot to a motorcycle wheel.

The brackets described above can all be made of standard materials, such as steel or high-strength aluminum. The cables and cable-mounting brackets can be constructed similar to standard cables and cable-mounting brackets that have been used in aircrafts, motorcycle brakes, and bicycles.

Referring to FIGS. 10 and 11, the alternative cable systems described above are illustrated in schematic form. The cable system (250) illustrated schematically in FIG. 10 is also illustrated in FIGS. 1-7, and is described above. Likewise, the cable system (512) illustrated schematically in FIG. 11 is also partially illustrated in FIGS. 8-9, and is described above. Referring to the schematic illustration in FIG. 10, the cable system of FIGS. 1-7 and 10 is arranged so that the following forces result in the following force transfers and movements:

TABLE 1

| Force | Resulting Movement & Force Transfer |
|---|---|
| Force applied to the toe end | This results in tension in the right toe cable (262), which pulls the |
| (214) of the right pedal | left side of the motorcycle fork (130) rearward, resulting in a left |
| (210) by an operator's foot. | pivot movement (610) of the front wheel (120), so that the front |
| | of the front wheel moves in the left lateral direction (612). As |
| | this happens, the right side of the fork (120) pulls on the left toe |
| | cable (282) and the right heel cable (252), so that the toe end |
| | (234) of the left pedal (230) is pulled back as the toe end (214) of |
| | the right pedal (210) is forced forward by the operator's foot. |
| Force applied to the heel | This results in tension in the right heel cable (252), which pulls |
| end (212) of the right pedal | the right side of the motorcycle fork (130) rearward, resulting in a |
| (210) by the operator's foot. | right pivot movement (620) of the front wheel (120), so that the |
| | front of the front wheel moves in the right lateral direction (622). |
| | As this happens, the left side of the fork (120) pulls on the right |
| | toe cable (262) and the left heel cable (272), so that the heel end |
| | (232) of the left pedal (230) is pulled back as the heel end (212) |
| | of the right pedal (210) is forced forward by the operator's foot. |
| Force applied to the toe end | This results in tension in the left toe cable (282), which pulls the |
| (234) of the left pedal (230) | right side of the motorcycle fork (130) rearward, resulting in a |
| by an operator's foot. | right pivot movement (620) of the front wheel (120), so that the |
| | front of the front wheel moves in the right lateral direction (622). |
| | As this happens, the left side of the fork (120) pulls on the right |
| | toe cable (262) and the left heel cable (272), so that the toe end |
| | (214) of the right pedal (210) is pulled back as the toe end (234) |
| | of the left pedal (230) is forced forward by the operator's foot. |
| Force applied to the heel | This results in tension in the left heel cable (272), which pulls the |
| end (232) of the left pedal | left side of the motorcycle fork (130) rearward, resulting in a left |
| (230) by an operator's foot. | pivot movement (610) of the front wheel (120), so that the front |
| | of the front wheel moves in the left lateral direction (612). As |
| | this happens, the right side of the fork (120) pulls on the left toe |
| | cable (282) and the right heel cable (252), so that the heel end |
| | (212) of the right pedal (210) is pulled back as the heel end (232) |
| | of the left pedal (230) is forced forward by the operator's foot. |

As is illustrated in FIG. 11, the cable system of FIGS. 8-9 and 11 is arranged so that the following forces result in the following resulting movements and force transfers:

TABLE 2

| Force | Resulting Movement & Force Transfer |
|---|---|
| Force applied to the toe end | This results in tension in the right pedal steering cable (520), |
| (414) of the right pedal | which pulls the left side of the motorcycle fork (402) rearward, |
| (410) by an operator's foot. | resulting in a left pivot movement (610) of the front wheel (404), |
| | so that the front of the front wheel moves in the left lateral |
| | direction (612). As this happens, the right side of the fork (402) |
| | pulls on the left pedal steering cable (530), so that the toe end |
| | (434) of the left pedal (430) is pulled back as the toe end (414) of |
| | the right pedal (410) is forced forward by the operator's foot. |
| Force applied to the heel | This results in tension in the tie cable (540), which pivots the left |
| end (412) of the right pedal | pedal (430) to produce a tension in the left pedal steering cable |
| (410) by the operator's foot. | (530), which pulls the right side of the motorcycle fork (402) |
| | rearward, resulting in a right pivot movement (620) of the front |
| | wheel (404), so that the front of the front wheel moves in the right |
| | lateral direction (622). The heel end (432) of the left pedal (430) |
| | is pulled back by the tension in the tie cable (540) as the heel end |
| | (412) of the right pedal (410) is forced forward by the operator's |
| | foot. |
| Force applied to the toe end | This results in tension in the left pedal steering cable (530), which |
| (434) of the left pedal (430) | pulls the right side of the motorcycle fork (402) rearward, |
| by an operator's foot. | resulting in a right pivot movement (620) of the front wheel |
| | (404), so that the front of the front wheel moves in the right |
| | lateral direction (622). As this happens, the left side of the fork |
| | (402) pulls on the right pedal steering cable (520), so that the toe |
| | end (414) of the right pedal (410) is pulled back as the toe end |
| | (434) of the left pedal (430) is forced forward by the operator's |
| | foot. |
| Force applied to the heel | This results in tension in the tie cable (540), which pivots the |
| end (432) of the left pedal | right pedal (410) to produce a tension in the right pedal steering |
| (430) by an operator's foot. | cable (520), which pulls the left side of the motorcycle fork (402) |
| | rearward, resulting in a left pivot movement (610) of the front |
| | wheel (404), so that the front of the front wheel moves in the left |
| | lateral direction (612). The heel end (412) of the right pedal |
| | (410) is pulled back by the tension in the tie cable (540) as the |
| | heel end (432) of the left pedal (430) is forced forward by the |
| | operator's foot. |

As described above, by applying pressure with the operator's right toes, the front wheel can be turned slightly to the left. This results in a right turn because of the counter-steering principles discussed above. Similarly, by applying pressure with the operator's left toes, the front wheel can be turned slightly to the right, which results in a left turn because of the counter-steering principles discussed above. Accordingly, an operator can simply apply a small force with the toe on the side to which the operator wants to turn to produce the desired turning effect. The cable system can be configured in different ways to produce different movements, such as by reversing the sides of the fork (130) to which each of the fork ends (256, 266, 276, 286, 524, and 534) of the cables (252, 262, 272, 282, 520, and 530) are attached, so that the results of the various forces on the front wheel (120 or 404) are reversed.

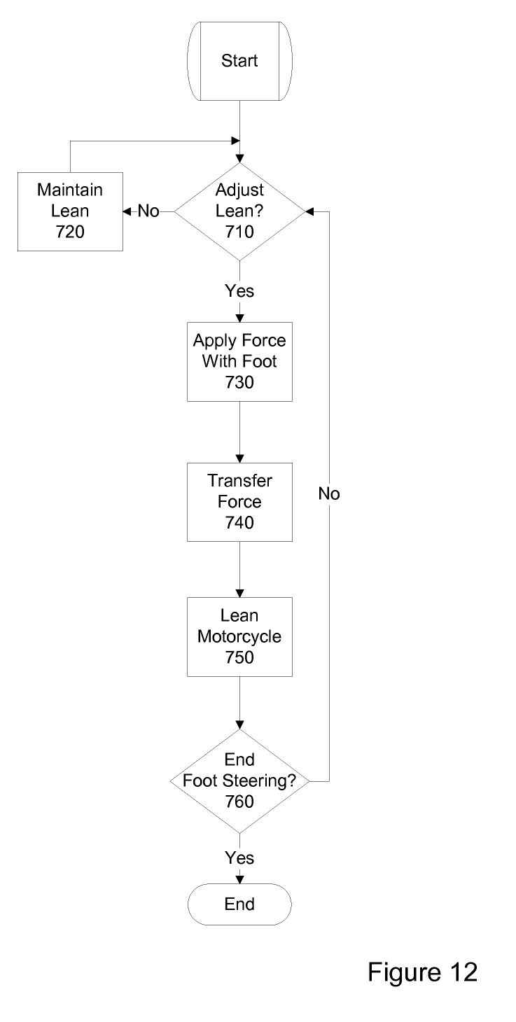

Referring now to FIG. 12, a method of steering a motorcycle will be described. This method can be performed with one of the steering systems described above, or with some other motorcycle foot steering system. For example, it could be performed using a foot steering system with foot steering pedals mounted directly on the front motorcycle fork, rather than being mounted to the motorcycle frame remotely from the front fork. As the motorcycle operator is operating a motorcycle, the operator decides (710) whether to adjust the lean of the motorcycle, which will adjust the motorcycle steering. If the answer is no, then the operator maintains (720) the present lean of the motorcycle. For example, the motorcycle operator may be going straight with the motorcycle upright, and the operator will continue with the motorcycle upright until the operator desires to turn. Similarly, if the motorcycle is leaning into an even turn, the operator may want to maintain the current lean into the turn for a period of time. If the operator does want to adjust the lean, such as to turn more or less sharply, or to straighten out of a turn, the operator applies (730) a force to a foot steering pedal using the operator's foot. This applied force is transferred (740) to pivot a motorcycle wheel, which results in the motorcycle leaning (750) to the right or left according to counter-steering principles discussed above. During a ride, an operator can continuously determine (760) whether to discontinue foot steering. This may be done, for example, because it is more desirable to steer solely with the operator's hand(s) or because the ride has ended. If so, then the steering method terminates. If not, then the steering method continues with the operator determining (710) whether to adjust the lean of the motorcycle.

The subject matter defined in the appended claims is not necessarily limited to the benefits described herein. A particular implementation of the invention may provide all, some, or none of the benefits described herein. Although operations for the various techniques are described herein in a particular, sequential order for the sake of presentation, it should be understood that this manner of description encompasses rearrangements in the order of operations, unless a particular ordering is required. For example, operations described sequentially may in some cases be rearranged or performed concurrently. Techniques described herein with reference to flowcharts may be used with one or more of the systems described herein and/or with one or more other systems. Moreover, for the sake of simplicity, flowcharts may not show the various ways in which particular techniques can be used in conjunction with other techniques. Moreover, directions such as up, down, forward, back, and rearward are provided for purposes of orientation to aid in describing the embodiments above, and it should be understood that the various parts described above could be oriented and positioned in many different ways.

While the invention has been particularly shown and described with reference to embodiments thereof, it will be understood by those skilled in the art that various changes in form and details may be made therein without departing from the spirit and scope of the invention. As another example, the foot steering pedals could include additional toe clips similar to standard bicycle toe clips to provide additional control.

I claim:

1. A motorcycle steering apparatus, comprising:
a foot pedal mounted on a motorcycle, the pedal being positioned to receive forces from a motorcycle operator's foot; and
a force transfer system configured to transfer forces on the pedal to pivot a motorcycle wheel in multiple pivotal directions and assist in steering the motorcycle.

2. The apparatus of claim 1, wherein the force transfer system is a mechanical system.

3. The apparatus of claim 2, wherein the mechanical system comprises at least one cable.

4. The apparatus of claim 1, wherein the apparatus further comprises handlebars secured to a front motorcycle fork.

5. The apparatus of claim 4, wherein the pedal is attached to a frame of the motorcycle.

6. The apparatus of claim 1, wherein:
the pedal is pivotally mounted so that the pedal can pivot about a pedal pivot in a first pedal pivot direction to pivot the motorcycle wheel in a first wheel pivot direction and the pedal can pivot about the pedal pivot in a second pedal pivot direction to pivot the motorcycle wheel in a second wheel pivot direction that is opposite from the first wheel pivot direction; and
the first and second wheel pivot directions are about a steering axis that is different from a driving rotation axis of the wheel.

7. The apparatus of claim 1, wherein the pedal is a first pedal, and the apparatus further comprises a second pedal positioned to be engaged by a motorcycle operator's foot, the force transfer system being configured to transfer pivotal forces on the second pedal to pivot the wheel of the motorcycle and assist in steering the motorcycle.

8. The apparatus of claim 7, wherein the force transfer system includes a first sub-system that transfers force from the first pedal, and a second sub-system that transfers force from the second pedal, such that the transfer system can transfer pivotal forces on the first pedal to pivot the wheel in multiple directions without the second sub-system, and the transfer system can transfer pivotal forces on the second pedal to pivot the wheel in multiple directions without the first sub-system.

9. A motorcycle comprising:
a rear motorcycle wheel;
a front motorcycle wheel supported by a front motorcycle fork;
a motor;
a pedal located to receive forces from an operator's foot; and
means for pivoting the front wheel in multiple directions about a steering axis and assisting in steering the motorcycle by transferring forces from the pedal to the front wheel.

10. The motorcycle of claim 9, wherein the pedal is a first pedal and the operator's foot is a first foot, and wherein the motorcycle further comprises:
a second pedal located to receive forces from a second foot; and
means for pivoting the front wheel in multiple directions about the steering axis and assisting in steering the motorcycle by transferring forces from the second pedal to the front wheel.

11. The motorcycle of claim 10, wherein the first and second pedals are each pivotally connected to a frame of the motorcycle.

12. The motorcycle of claim 9, wherein transferring the force from the motorcycle operator's foot to the front wheel comprises transferring the force from the motorcycle operator's foot to a front fork of the motorcycle.

13. The motorcycle of claim 12, wherein the means for pivoting the front wheel and assisting in steering comprises at least one cable connecting a left pedal to the front fork of the motorcycle and at least one cable connecting a right pedal to the front fork of the motorcycle.

14. The motorcycle of claim 12, wherein the means for pivoting the front wheel and assisting in steering comprises at least one cable connecting the left pedal to a right side of the front fork of the motorcycle and at least one cable connecting the right pedal to a left side of the front fork of the motorcycle.

15. A method comprising:
applying a first force from a motorcycle operator's foot to a toe region of a device attached to a motorcycle; and
transferring the first force from the device to a motorcycle wheel, the transferred force pivoting the motorcycle wheel in a first direction about a steering axis that is different from an axis of rotation of the motorcycle wheel;
applying a second force from the foot to a heel region of the device; and
transferring the second force from the device to the motorcycle wheel, the transferred second force pivoting the motorcycle wheel in a second direction about the steering axis, the second direction being opposite the first direction.

16. The method of claim 15, wherein:
the device is on a first side of the motorcycle; and
pivoting the motorcycle wheel in the first direction comprises pivoting the motorcycle wheel so that a front of the motorcycle wheel moves laterally toward a second side of the motorcycle that is opposite from the first side of the motorcycle.

17. The method of claim 15, wherein the transferred force pivots the motorcycle wheel in a first wheel pivot direction, wherein a front portion of the motorcycle wheel moves in a first lateral direction relative to a rear portion of the motorcycle wheel.

18. The method of claim 17, wherein the method further comprises:
leaning the motorcycle in a second lateral direction, which is opposite from the first lateral direction; and
turning the motorcycle in the second lateral direction.

19. The method of claim 15, wherein the moveable member of the motorcycle comprises a pedal.

20. The method of claim 19, wherein transferring the force from the moveable motorcycle member to a motorcycle wheel comprises transferring the force from the pedal and through a front fork of the motorcycle.

21. The method of claim 20, wherein transferring the force from the moveable motorcycle member to a motorcycle wheel comprises applying a tension to a cable between the pedal and the front fork.
